(19) United States
(12) Patent Application Publication
(10) Pub. No.: US 2007/0057535 A1
(43) Pub. Date: Mar. 15, 2007

(54) Method and device for the production of a component, especially a hybrid component for a crossrail of a vehicle, component and use of said component

(75) Inventor: Walter Wolf, Oppenweller-Zell (DE)

Correspondence Address: FOLEY AND LARDNER LLP;SUITE 500, 3000 K STREET NW, WASHINGTON, DC, 20007, US

(73) Assignee: BEHR GMBH & CO.KG

(21) Appl. No.: 10/574,771

(22) PCT Filed: Oct. 8, 2004
(86) PCT No.: PCT/EP04/11279

§ 371 Date: Aug. 28, 2006

(30) Foreign Application Priority Data
Oct. 8, 2003 (DE) 103 47 230.4
Feb. 24, 2004 (DE) 10 2004 009 413.6

(51) Int. Cl. B60K 37/00

(52) U.S. Cl. 296/193.02

(57) ABSTRACT

The invention relates to a method for the production of a component (1) comprising a base body (2) which is at least partially covered in plastic (2), particularly a hybrid component, for a crossrail of a vehicle or a front-end-component. The base body (2) is made of at least two elements (2a, 2b) which are connected together on at least one connection point (8a, 8b, 8c, 8d). The inner wall of the base body (2) is covered with plastic (4) in such a manner that a cavity (H) is formed in the region of one of the connection points (8a, 8b) between the connection points (8a, 8b) and the plastic (4). The invention also relates to a component (1), especially a hybrid component, for a crossrail of a vehicle, comprising a base body (2) which is at least partially covered by plastic, said base body being formed from at least two elements (2a, 2b) whereon at least one of the connection points (8a, 8b, 8c, 8d) can be joined together. The inner wall of the base body (2) is provided with plastic (4) in such a manner that a cavity (H) is formed in the region of one of the connection points (8a, 8b) between the connection point (8a, 8b) and the plastic (4).

The invention relates to a method and a device for manufacturing a component comprising a base body which is at least partially lined with plastic, said component being in particular a hybrid component for a transverse beam of a vehicle. Furthermore, the invention relates to a component, in particular a hybrid component, and to the use of such a component.

Transverse beams which are formed from tubes which are composed of metal and have correspondingly large wall thicknesses are known from motor vehicle engineering. The wall thicknesses are appropriately embodied here so as to provide sufficient dimensional rigidity, bending strength, buckling strength and torsional rigidity and a sufficient compressive-load bearing capacity. The transverse beam which is embodied as a tubular section or hollow section is in principle suitable for guiding air, for example from an air conditioning system arranged centrally in the front region of the vehicle to lateral vents.

Such a transverse beam is known, for example, from DE 100 64 522 A1. Here, in order to reduce the weight, the transverse beam is formed from a lightweight material, in particular from a lightweight metal in the manner of a shell component or base body in which a plastic core which forms at least one duct is arranged in order to provide the transverse beam with sufficient rigidity and a sufficient compressive-load bearing capacity. In order to allow the air stream to exit, the duct is provided with openings.

Such a component which is formed from a metallic base body and a plastic core is usually manufactured in a plurality of shaping stages. In this context, in a first step the metallic base body is given an original shape in a shaping tool and then the plastic core is introduced in an injection molding tool. This results both in a large number of shaping stages and in a complex tool technology. In general, elements such as, for example, sheet-metal shell structures, of the base body are provided with a connection to a sheet-metal collar which is formed by the two sheet-metal shell structures. When an internal plastic lining, for example the plastic core, is provided by injection molding inside the base body, mechanical and/or thermal loading of the plastic lining or internal plastic lining may occur in the region of the connection when the sheet-metal shell structures are connected. Alternatively, the plastic lining which is formed by injection molding is itself used as a connecting element for the two sheet-metal shell structures by virtue of the fact that the plastic protrudes at corresponding openings in the base body.

The invention is based on the object of specifying a particularly simple and cost-effective method and a particularly suitable device for manufacturing a component which is embodied as a hybrid component, in particular the use of the component as a flow duct being made possible by a correspondingly improved design of the component. Furthermore, a component with an improved design is to be specified.

The object is achieved according to the invention by means of the features of claim 1 with respect to the method, by means of the features of claim 19 with respect to the device and by means of the features of claims 40 to 43 with respect to the uses of a component which is manufactured in such a way. The object with respect to the component is achieved by means of the features of claim 26.

Advantageous developments of the invention are the subject matter of the subclaims.

The invention is based on the idea that when manufacturing a component such as a hybrid component for a transverse beam of a vehicle, plastic elements are inserted, integrally molded or integrally injection molded onto the inside and/or outside of a metallic base body or sheet-metal part by means of a plurality of tools and a large number of method steps, or the metallic base body is encapsulated by injection molding at least partially with plastic, at least on the inside. In order to make the component as easy as possible to handle during the manufacturing process, the base body is preferably formed from a plurality of elements, in particular from two elements, for example from two half shells or a half shell and a lid, which can be preshaped in a shaping element. In order to use the component as an air guiding duct or to embody the component as a hollow element, the individual elements of the base body are connected to one another mechanically, in particular by caulking, compression bonding, clinching or by means of the integrally molded, in particular injection molded or inserted plastic core, by forming a duct. In order to form a sufficiently good connection between the elements of the base body in terms of the best possible protection against mechanical loading and the best possible sealing of the base body when it is used as a flow duct, the elements of the base body are joined and connected to one anther in the region of the connection point of the two elements in such a way that a cavity is formed between the connection point and the plastic lining. In particular, the plastic structure which is inserted or injection molded in the manner of a plastic lining has a cross section which is smaller compared to the cross section of the base body by virtue of the fact that the plastic structure is provided with a depression or a bulge, in particular in the region of at least one of the connection points.

The size of the cavity is expediently predefined as a function of the type of the connection point and/or the thickness of the plastic. Depending on the use of the component, the cavity can have a minimum distance between the connection point and the plastic of at least 0.8 mm and at most 25 mm, in particular from 0.8 mm to 5 mm, from 5 mm to 10 mm, from 10 mm to 15 mm, from 15 mm to 20 mm or from 20 mm to 25 mm. In particular the minimum distance is predefined to be of such a size that a sufficiently large heat conduction path is brought about between the connection point and the plastic or the plastic structure. For example, a sufficiently large minimum distance is predefined when there is a thermal connection for example when the elements of the base body are welded, whereas when there is only a mechanical connection between the elements, for example by means of bonding, a relatively small minimum distance is predefined and the cavity is made correspondingly smaller. For example, the elements are connected to one another in a mechanical and/or materially joined fashion in particular by welding, bonding, soldering, clinching, chamfering, caulking and/or by means of the integrally molded, in particular integrally injection molded, plastic layer. In other words, the size of the cavity and/or the minimum distance between the connection point and the plastic lining is predefined as a function of the selected type or form of connection.

In order to provide the best possible supporting structure and supporting design of the component, the base body is expediently at least partially coated by a plastic, in particular encapsulated by injection molding. Alternatively or additionally, the plastic can be separately premolded and subsequently inserted into the base body. The base body is preferably provided with plastic on the inside and/or outside. The plastic is also preferably applied in a single layer or multiple layers and/or with a thickness which varies in certain areas. For the best possible bending strength, denting resistance and torsional strength of the component the plastic is preferably applied in a positively locking and planar fashion. The plastic layer brings about both good structural rigidity and thermal insulation and/or sound insulation for a plastic structure which is embodied as a duct and through which a gas or liquid flows. In addition, one of the plastic layers can be provided with reinforcement, in particular with reinforcing fabric, for example a glass fiber fabric.

The base body which is partially lined with plastic can advantageously be of perforated design at least in certain areas. This is expediently done in an opening region, for example. Such a base body has, in particular, the advantage of saving weight and/or reinforcing the structure.

Alternatively or additionally, the base body is provided with a plastic structure, in particular with a plastic reinforcing structure, for example internal ribbing, or with a plastic guiding structure, for example a flow duct or a directing or guiding element. Depending on the type and function of the component, the plastic is applied with differing thicknesses between 0.8 mm and 10 mm, in particular with a thickness of 0.8 mm to 3 mm, from 3 mm to 6 mm or from 6 mm to 10 mm, preferably 1.2 mm to 3 mm. The plastic is preferably introduced in a single component or multicomponent injection molding method which is known per se.

A base element which is formed from a metal, lightweight metal or its alloys, in particular aluminum, magnesium or refined steel, is preferably used with a wall thickness of 0.4 mm to 2.0 mm, preferably also from 0.4 mm to 1.5 mm or 1.5 mm to 2.0 mm or, in particular depending on the strength of the material, also to 3.0 mm. Such a metallic base body or a sheet-metal part is particularly cost-effective and particularly suitable in the vehicle industry for lightweight construction which is designed to reduce weight. Depending on the type and function of the component, the base body can be formed with a wall thickness which varies in certain areas. For example, when the component is used as a transverse beam, it can be embodied with a thicker wall thickness in the region of mounts and force application points in the vehicle, for example connection to an A pillar, in the steering region, connection of an air conditioning system or in the regions of the longitudinal beams, the engine bearings or the bonnet closure in the case of front ends, than in the region in which the component serves merely as an air guiding duct, as a mount carrier or for other functions. Such sheet-metal parts are available as tailored blanks (welded together in certain areas), tailored rolled blanks (rolled with different thicknesses in the rolling direction), sectional ribbon (for example thick at the edge, thin in the middle) or as patchwork sheet-metal parts (as in a puzzle, but each part is joined to the sheet metal blank with a differing wall thickness).

In order to reduce, in particular, the number of tools but also to reduce the number of method steps when manufacturing the component, in particular the hybrid component, the component is advantageously manufactured by means of just a single tool, in particular a shaping tool and/or joining tool. In this context, the base body is inserted into the shaping and/or joining tool, in particular its shaping element, and premolded or joined at least partially or completely by closing the shaping and/or joining tool, and it is subsequently possible to form a cavity between the connection point and the plastic when the plastic is introduced into the base body in the region of a connection point of the two elements of the base body. In this context, when the base body is inserted that location or position of the shaping and/or joining tool which is provided as a cavity for introducing the plastic in the case of a plastic-coated design of the base body or as a cavity for inserting the premolded plastic in the case of a plastic-joined design of the base body, is easily used in accordance with the way in which the base body is shaped. If the cavity is present on both sides of the base body, on the upper side and lower side, the base body changes its shape at this point as the plastic is introduced by means of the injection pressure or filling pressure or as the premolded plastic is joined on, and the base body matches itself to the contour of the shaping and/or joining tool. As a result the base body itself can be premolded, partially molded and compression molded in the shaping and/or joining tool in a targeted fashion and as a result of corresponding dimensions of the shaping and/or joining tool.

In this context, the shaping and/or joining tool advantageously has a side which produces the shape corresponding to the contour of the base body, in particular an inner wall. In particular, the shaping and/or joining tool is designed for coating or lining the base body with plastic on one side or both sides. The shaping and/or joining tool has corresponding dimensions for coating so that after the base body has been premolded, at least one gap which runs completely or partially around it is formed on one or both sides of said base body, said gap being provided to hold the plastic.

The base body is expediently premolded in the shaping and/or joining tool by introducing at least one tool element which provides a shape, for example by means of a die. This permits largely precise and sufficiently good premolding or prefabrication of the base body already in the shaping and/or joining tool. Furthermore, this provides prefabrication with a small number of shaping stages. The base body is preferably compression molded in a post-pressure phase into a predefined final form by pressing in and/or pressing through the shaping and/or joining tool.

In order to premold the base body as flexibly as possible, the shaping and/or joining tool is formed in one part or a plurality of parts. In particular, the shaping and/or joining tool comprises an upper tool and/or a lower tool which can in turn preferably be in one part or a plurality of parts. In order to form the base body with a surface structure in the form of various patterns such as, for example, grooves or cross patterns, the shaping and/or joining tool, in particular the upper tool and/or lower tool, is provided with at least one bead. Furthermore, the shaping tool and/or joining tool is provided, for internal lining of the cavity of the base body, with a plastic structure, for example a plastic reinforcing structure and/or a plastic guiding structure, with at least a further shaping element.

In terms of the component, in particular of a hybrid component for a transverse beam of a vehicle, the component has, as explained above by way of example with reference to the manufacturing method, a base body which is at least partially lined with plastic and which is formed from at least two elements which can be connected to one another at at least one connection point, the base body being provided on its inner walls with plastic in such a way that a cavity is formed in the region of one of the connection points between the respective connection point and the plastic. In particular, the plastic is arranged, for example injection molded, joined and/or inserted, in the base body in the manner of a plastic structure. In this context, the plastic structure has a cross section which is smaller than the cross section of the base body in that a cavity with a minimum distance between the metallic base body and the internal plastic structure is formed during the connection process in the region of the connection points with high thermal and/or mechanical loading. Depending on the predefined values, the minimum distance can be from 0.8 mm to 25 mm, in particular from 0.8 mm to 5 mm, from 5 mm to 10 mm, from 10 mm to 15 mm, from 15 mm to 20 mm or from 20 to 25 mm. The minimum distance depends, inter alia, on the size of the cross section of the base body and/or the plastic structure in the region of the connection point, on the type of connection point and/or on the thickness of the plastic structure.

The base body is made of a metal and/or lightweight metal, for example from aluminum, magnesium or refined steel, and has a wall thickness of 0.4 mm to 1.5 mm, to 2 mm or to 3.0 mm. The wall thickness of the metallic base body can vary, in particular the base body has a sufficiently large wall thickness in the region with securing elements which are arranged on the base body, for example a securing element for an air conditioning system.

The component can also be manufactured using a different manufacturing method from the manufacturing method explained in more detail above. The manufacturing method described here for a component with metal/plastic connections in certain areas is a particularly simple and cost-effective method and permits subsequent joining or injection molding of the plastic as a plastic structure.

A component which is manufactured according to the method described above is preferably used as an instrument panel beam in a vehicle, the plastic core forming one or more ducts, in particular an air guiding duct and/or a cable duct. Alternatively, a component which is manufactured in such a way can be used as a transverse beam in a vehicle, in particular as a transverse beam between the A pillars of a vehicle. Alternatively, a component which is embodied in such a way can be used as a transverse beam which is arranged under a windshield in a motor vehicle, the duct being an air guiding duct for guiding an air stream which is to be fed to the windshield and/or the side windows and/or for heating a windshield wiper support. The component could also be used as what is referred to as a rear end or rear-end termination module.

The advantages achieved with the invention consist, in particular, in the fact that a particularly simple and cost-effective manufacturing method is provided by a component which is easily completely formed in such a tool and lined with plastic, said method permitting largely satisfactory use of the component as a flow duct or guiding duct by selecting the connection points and a cavity which is dependent thereon, between the connection point and the plastic lining. In addition, the component can be manufactured with a particularly simple tool. The number of method steps and thus the manufacturing time of a hybrid component is also significantly reduced.

Exemplary embodiments of the invention are explained in more detail with reference to a drawing, in which:

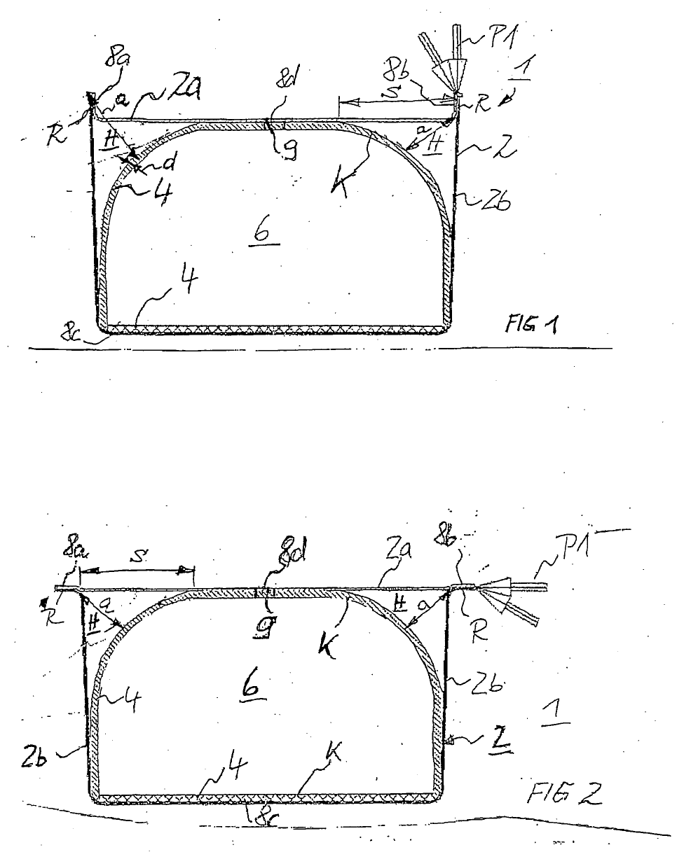

FIGS. 1 to 5 show schematic views of different embodiments of a completed component with an at least partially plastic lined base body and various connection points for elements of the base body,

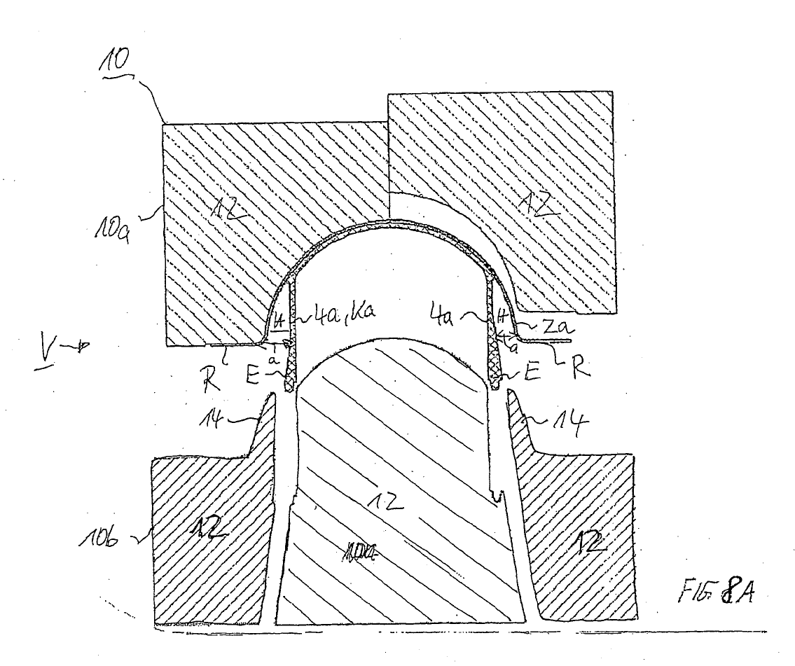

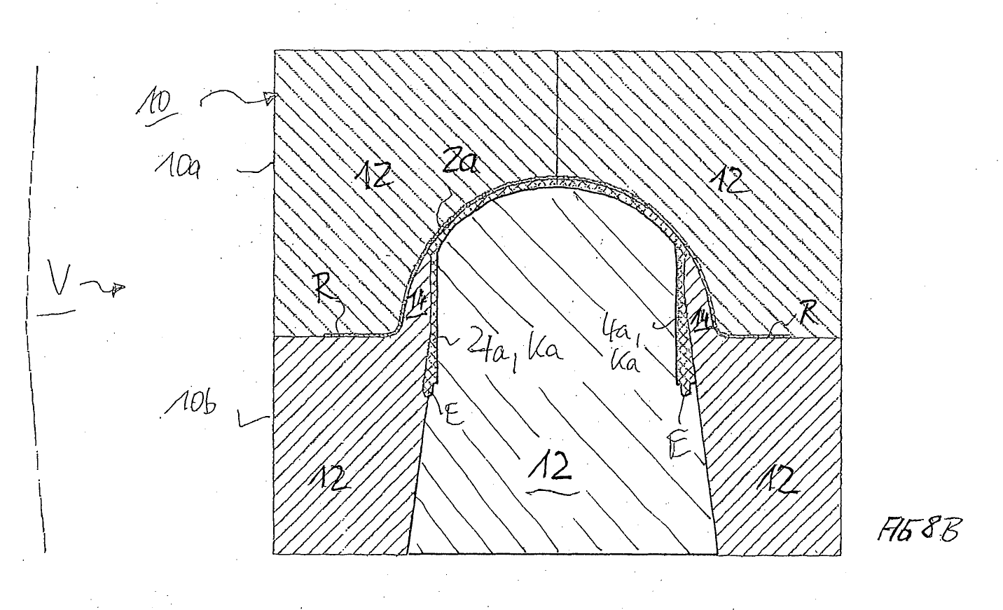

FIGS. 6A to 7B show schematic views of various embodiments of the plastic lining of a base body,

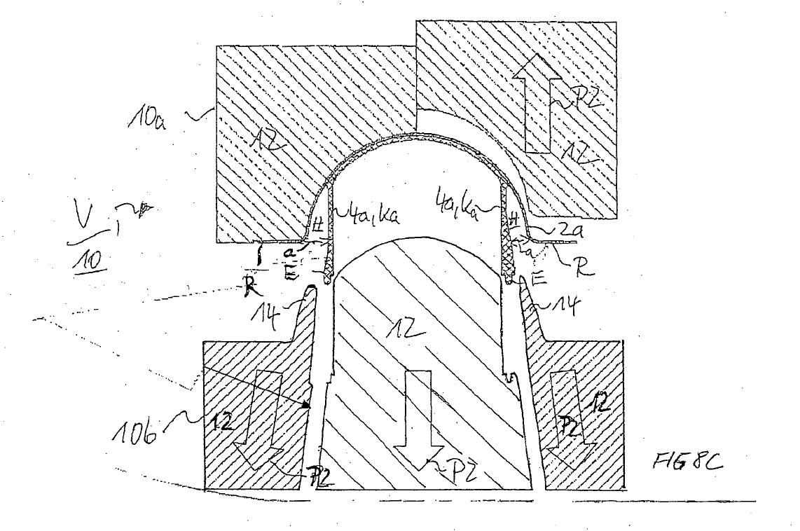

FIGS. 8A to 8C are schematic views of the method steps for manufacturing a component comprising an at least partially plastic lined base body in a device which comprises a shaping and joining tool,

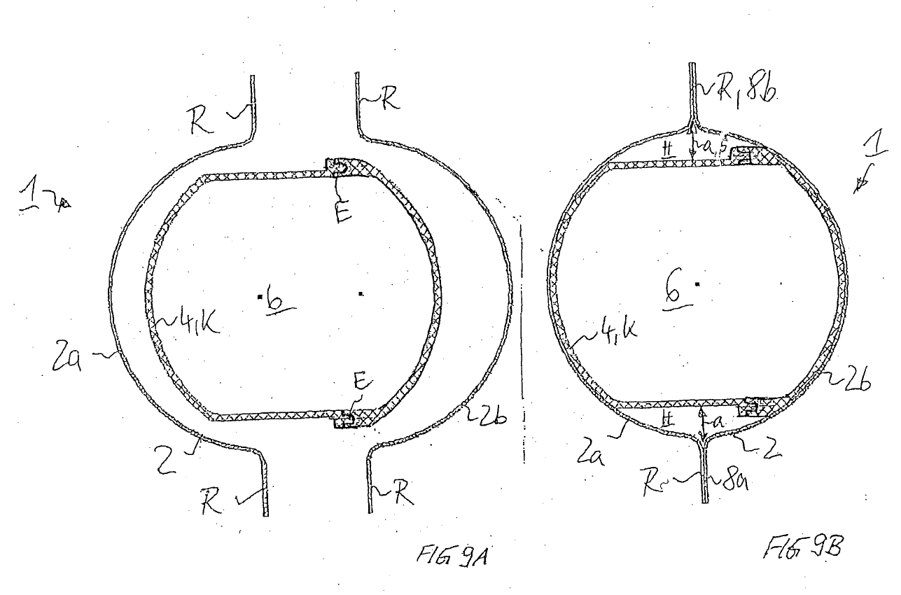

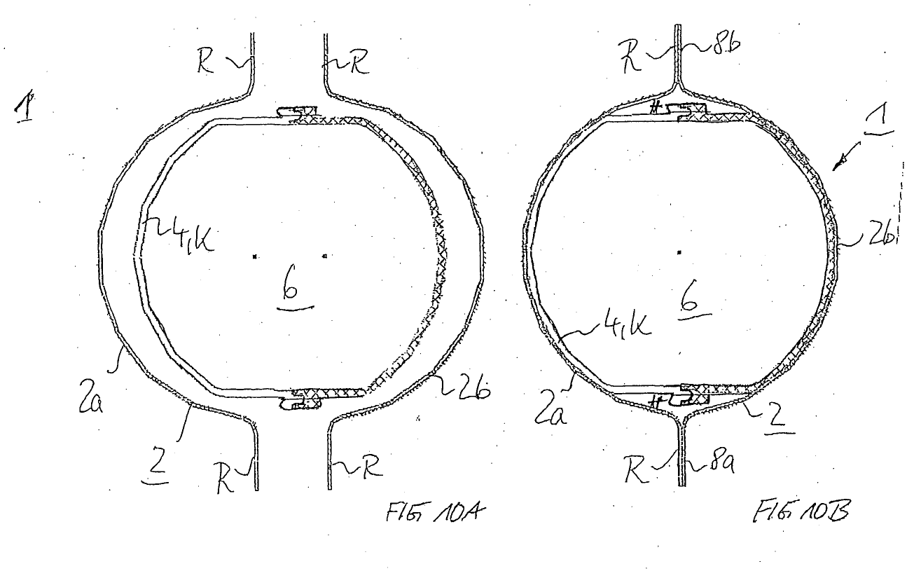

FIGS. 9A to 10B show schematic views of various embodiments of a base body with an inserted plastic lining,

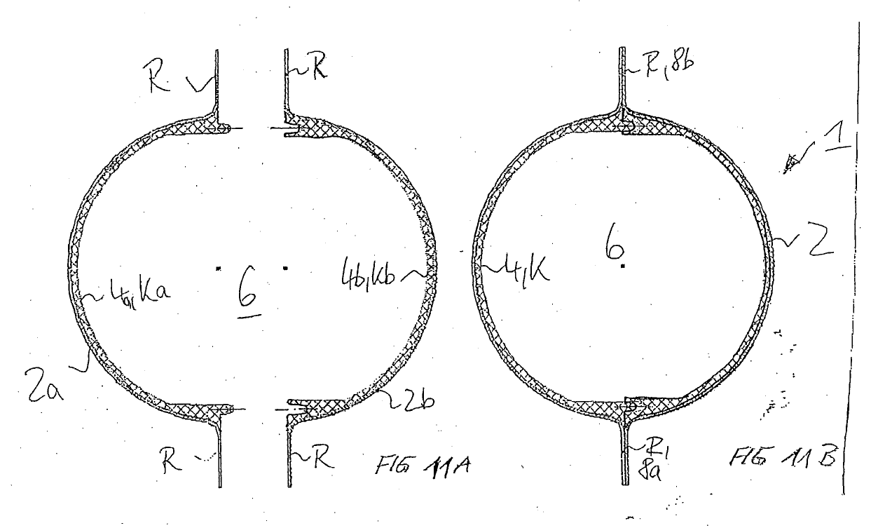

FIGS. 11A to 11B show schematic views of an embodiment of a base body with a plastic coating, and

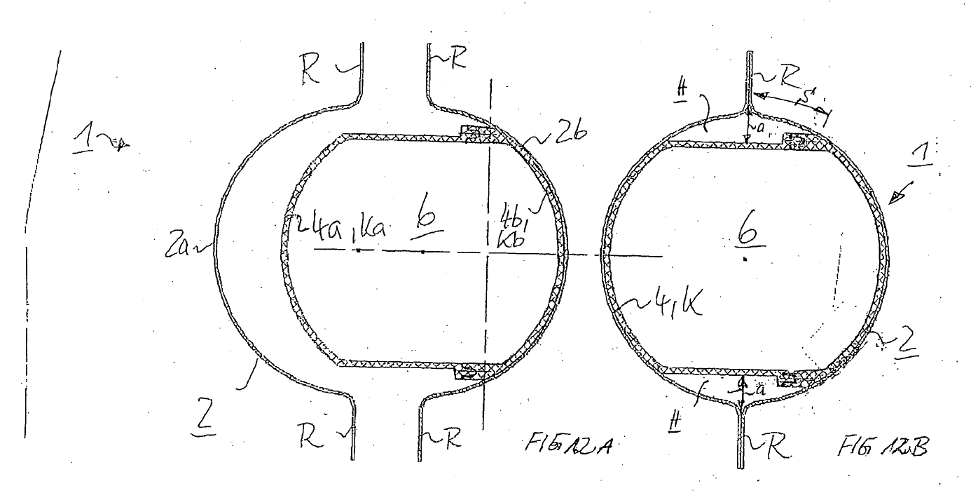

FIGS. 12A to 12B show schematic views of an embodiment of a base body with a partial plastic coating and a partially inserted plastic lining.

Parts which correspond to one another are provided with the same reference symbols in all the figures.

FIG. 1 shows, in cross section, a component 1, for example a transverse beam, to be arranged between A pillars (not illustrated in more detail) of a vehicle (not illustrated in more detail).

For this purpose, the component 1 has a base body 2 which is preferably formed from sheet metal, in particular from a lightweight sheet metal, for example from sheet aluminum, sheet magnesium or refined sheet steel. The base body 2 is embodied in the exemplary embodiment as a hollow section, in particular in the manner of a box. Alternatively, the base body 2 can also be embodied as a hollow section with a round cross section. In one possible embodiment, the base body 2 is formed from two elements 2a and 2b, for example a U section or lower shell and a lid.

The base body 2 is provided on the inside with plastic 4 which forms a plastic structure K, for example a duct 6. The plastic 4 can be joined, inserted or integrally injection molded in the form of a plastic lining here.

In order to use the duct 6 formed by the plastic structure K as well as possible for the purpose of guiding a medium, for example air for the purpose of air conditioning the passenger compartment of a vehicle or alternatively lines or cables, the two elements 2a and 2b are to be sufficiently firmly connected to one another. For this purpose, the component 1 has at least one connection point 8a to 8d. For example, the base body 2 is joined mechanically and/or in a materially joined fashion at the connection points 8a and 8b. In this context, the base body 2 can be riveted, screwed, welded, bonded, chamfered, caulked, clinched or connected in some other way by caulking at the edges R of the elements 2a, 2b lying opposite one another. As a result, the connection point 8a, 8b and the plastic 4 arranged in the region of the connection point 8a, 8b can be loaded mechanically and/or thermally.

For this purpose, the two elements 2a and 2b of the base body 2 are lined on the inner walls with the plastic 4 in such a way that in the region of at least one of the connection points 8a or 8b a cavity H is formed between the respective connection point 8a or 8b and the plastic 4. For this purpose, the plastic structure K has a smaller cross section than the cross section of the base body 2. In particular, the plastic structure K has an arcuate shape in the region of the respective connection point 8a, 8b, i.e. the plastic structure K has an identical shape to the base body 2 only in certain areas, for example in the region of the connection points 8c and 8d. In other words, in the region of the connection points 8a and 8b the plastic structure K can be provided with a bulge or a depression in order to form the cavity H. By forming the cavity H and the minimum distance a it is ensured that when the elements 2a and 2b of the base body 2 are connected at the connection points 8a, 8b, damage does not occur to the plastic structure K owing to the type of connection.

The size of the cavity H is predefined, for example, as a function of the type of the connection point 8a, 8b and/or the thickness d of the plastic 4. For example, the cavity H can be made larger when there is a welded connection than when there is a clinch connection. The arrow P1 shows the weld orientation for a weld connection.

Furthermore, the cavity H is given such a size that a minimum distance a is defined between the respective connection point 8a or 8b and the plastic 4 of at least 0.8 mm and at most 25 mm, in particular of 0.8 mm to 5 mm, of 5 mm to 10 mm, of 10 mm to 15 mm, 15 mm to 20 mm, of 20 mm to 25 mm.

In addition, the base body 2, in particular its two elements 2a and 2b, can be held together at the connection points 8c and 8d by means of the plastic 4. For example, plastic 4 is joined to the base body 2 at the connection point 8d by means of an opening 9 and is connected to the base body 2 at the connection point 8c by means of self-adhesion brought about by a thermal method.

The plastic structure K which is formed from the plastic 4 has the purpose, in the manner of a plastic lining, of increasing the rigidity of the base body 2, inter alia. The base body 2 which is of particularly thin-walled construction causes noise to be generated when air flows through it, which noise is particularly advantageously damped by lining the base body 2 with the plastic 4. That is to say the plastic 4 performs a sound insulation function and if appropriate also a thermal insulation function.

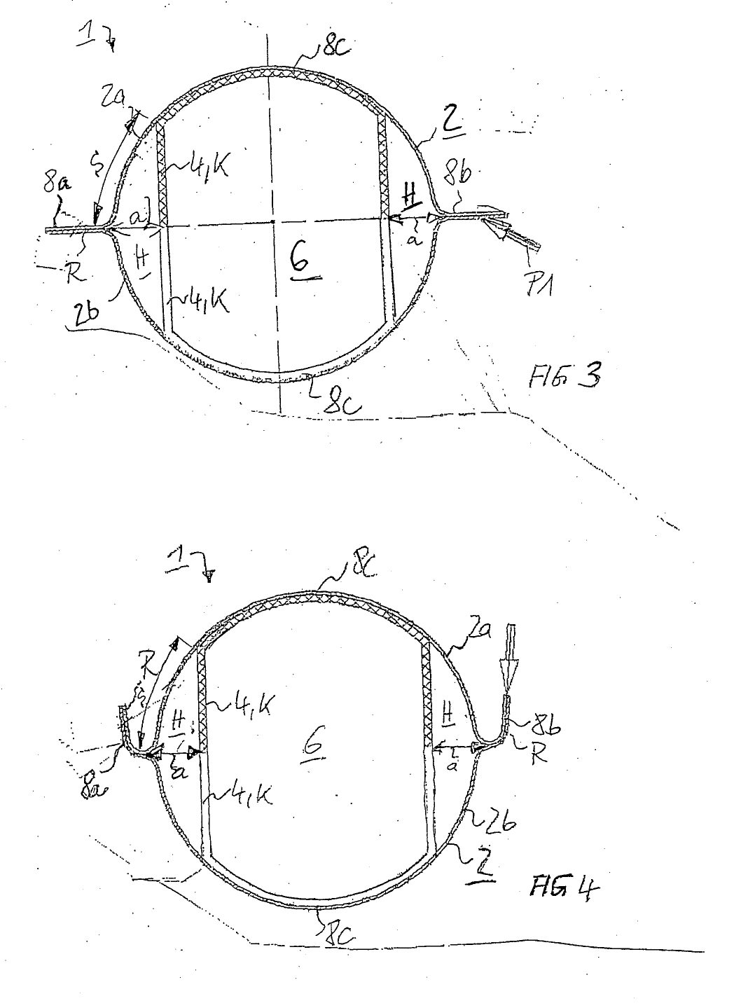

FIG. 2 shows in cross section an alternative embodiment of a component 1 with a base body 2 composed of the elements 2a and 2b, which are connected to one another by means of the edges R at the connection points 8a and 8b, and by means of the plastic 4 at the connection points 8c and 8d. Arrow P1 shows here the welding orientation which is changed for a welded connection of the connection point 8b compared to FIG. 1.

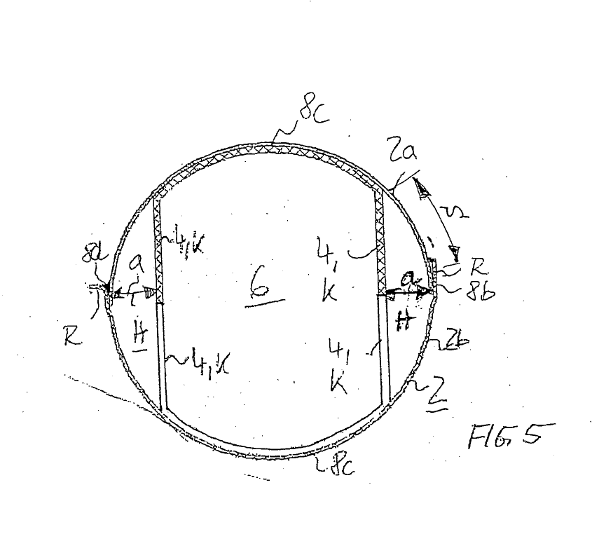

FIG. 3 shows in cross section an alternative embodiment of a component 1 with a base body 2 composed of the elements 2a and 2b. The base body 2 is embodied as a hollow cylinder which is formed from two half shell elements 2a, 2b. The two half shell elements 2a and 2b form a circular cross section and have protruding elements which form the edges R for the connection points 8a and 8b. Arrow P1 shows here the weld orientation which is necessary for a welded connection of the connection point 8b. For a sufficiently large minimum distance a or a thermal connection path S between the respective connection point 8a, 8b to the plastic structure K, the latter has, instead of a round cross section like the cross section of the base body 2, a largely box-shaped cross section so that a cavity H is formed between the plastic structure K and the respective connection point 8a, 8b. Owing to the connection by means of integrally injection molded or joined plastic 4, the elements 2a, 2b are also indirectly connected by means of the plastic 4 itself in the region of the connection point 8c.

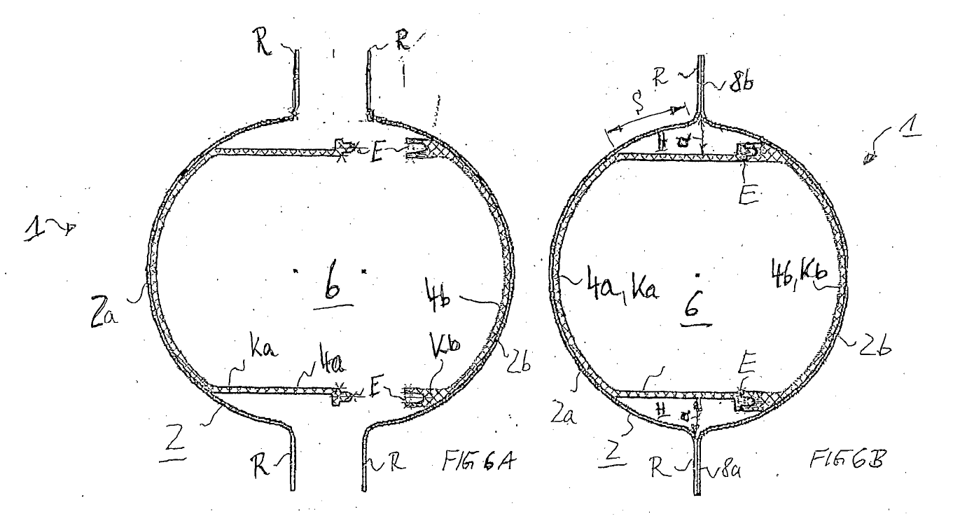

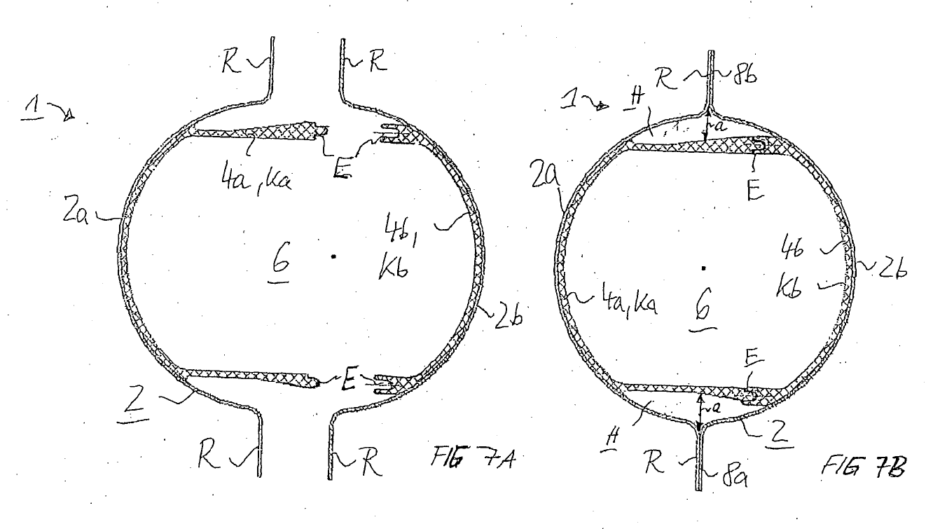

FIGS. 4 and 5 show in cross section various embodiments of a component 1 according to FIG. 3 with differently implemented connection points 8a and 8b for welding (FIG. 4) and for soldering (FIG. 5). Here too, a correspondingly large cavity H is formed between the respective connection point 8a, 8b to the plastic structure K with a sufficiently large minimum distance a or with a sufficiently large thermal conduction path S.

FIGS. 6A, 6B and 7A, 7B show various embodiments of a component 1 with a base body 2 which is formed from two half shell elements 2a and 2b and has a circular cross section. Here, the respective half shell elements 2a and 2b are prefabricated with the plastic structure K which has been injection molded inside or inserted/integrally joined (FIGS. 6A and 7A) and then joined and connected to one another at the connection points 8a, 8b (FIGS. 6B and 7B). The plastic structure K is constructed in two parts here and has, for the connection, correspondingly shaped and corresponding ends E which are joined to one another when the elements 2a and 2b are connected. That is to say the respective element 2a or 2b forms a single, prefabricated part with the associated half shell plastic structure Ka or Kb. The prefabricated elements 2a and 2b are then assembled to form the component 1.

FIGS. 8A to 8C show the steps for manufacturing a component 1 illustrated in the FIGS. 1 to 7B described above. Here, the metallic base body 2 is used as a carrier for the component 1. Depending on the shape of the component 1, the base body 2 may already be preshaped. Alternatively, the base body 2 may be preshaped in a device V shown in FIG. 8A, in particular in a shaping and/or joining tool 10. Alternatively, the shaping and joining tool 10 can also be embodied with an open shape (in a way which is not illustrated in more detail), in which case either the half shells or the elements 2a, 2b of the base body 2 are lined with plastic 4 or joined subsequently or a plastic structure K is subsequently inserted between the elements 2a, 2b.

Depending on the type and design, the shaping and joining tool 10 can be embodied as a single part or as a plurality of parts. The shaping and joining tool 10 is embodied in two parts here and comprises an upper tool 10a and a lower tool 10b. For example, as shown in FIG. 8A, the upper tool 10a and the lower tool 10b can in turn be embodied as a plurality of parts. In this context, the upper tool 10a has two shaping elements 12, for example two open half cylinders, which are arranged one next to the other. The lower tool 10b comprises two shaping elements 12 which are arranged one inside the other, for example a solid core and a further shaping element which surrounds the solid core.

The shaping elements 12 are used to shape the base body 2 further. Furthermore, one of the shaping elements 12 can be used to hold down the base body 2 during the shaping process. By inserting the individual shaping elements 12 of the upper tool 10a, the base body 2 which is inserted in the shaping and joining tool 10 can be partially preshaped, as shown in FIG. 8A. Otherwise, the shaping elements 12 are used to form cavities H in which a plastic mass is introduced.

FIG. 8A shows in more detail the manufacture of one of the elements 2a of the base body 2. The other element 2b can be manufactured in the same shaping and joining tool 10, the shaping element 12 which is embodied as a solid core or die being replaced and another die with a correspondingly formed external shape being used to form the different ends E of the plastic structure which is formed in two halves Ka, Kb. When the half shells are subsequently joined, the base body 2, in particular one of the elements 2a, is inserted into a shaping element 12 of the upper tool 10a of the shaping and joining tool 10 in order to manufacture a component 1 according to FIG. 8A. By at least partially or completely closing one of the shaping elements 12, the base body 2 is preshaped according to the shape or contour of the shape predefined by the shaping elements 12. When the element 2a with the plastic structure Ka is shaped as shown in FIG. 8A, a cavity H is formed between the base body 2 and the wall of the plastic structure Ka by a corresponding shaping 14 of the lower shaping element 12 of the lower tool 10b in the region of the edges R. In the region of the shell shape of the element 2a, the plastic 4 is injected, inserted or joined on so that the base body 2 is lined at least partially with the plastic layer 4, in particular encapsulated by injection molding or foam encapsulated.

The size of the cavity H is predefined as a function of the shape of the respective shaping element 12 with the applied shaping. Preferably, the cavity H has a minimum distance a between the outer wall of the plastic structure Ka and the respective edge R of the element 2a. In particular in order to obtain a sufficiently large thermal conduction path S, the minimum distance a is at least 0.8 mm and at most 25 mm, for example 0.8 mm to 5 mm, 5 mm to 10 mm, 10 mm to 15 mm, 15 mm to 20 mm or 20 mm to 25 mm.

Depending on the configuration of the shaping and/or joining tool 10 and the preshaping of the base body 2, the latter can be provided with a plastic layer 4 on the inside and/or outside. Furthermore, by introducing plastic in a plurality of phases, said plastic can be molded onto the base body 2 in a single or a plurality of layers.

In a post-pressure phase, the base body 2 is subsequently compression molded into a predefined final form, for example by pressing the shaping elements 12 in and/or through the upper and/or lower tool 10a or 10b in order to shape the base body 2 as precisely as possible to the contour with the plastic layer 4. As a result, the plastic layer 4 is molded on to the base body 2 in a planar fashion and in a way which is particularly positively locking for a long time.

FIG. 8B shows the shaping and joining tool 10 in a completely closed state.

In order to obtain a component 1 which is as lightweight as possible and which at the same time can be shaped particularly easily, the metallic base body 2 is preferably formed from a base body 2 which is formed from lightweight metal, in particular aluminum, magnesium or refined steel with a wall thickness of 0.4 mm to 2.0 mm. The base body 2 is preferably formed with a wall thickness which varies in certain areas so that further elements, for example a deflection element, an air conditioning system, air inlets and/or air outlets, can be integrated onto the component 1 in certain sections.

Depending on the type of plastic lining of the base body 2 with integrally injection molded or joined on plastic 4, for example in the case of an integrally injection molded plastic structure K molten plastic is introduced into the shaping and joining tool 10 in a subsequent method step so that, by means of the injection pressure, the base body 2 is additionally compression-molded with the plastic 4 with a predefined formation corresponding to the contour of the shaping elements 12.

The plastic 4 is for this purpose introduced via at least one duct (not illustrated in more detail) with a predefined injection pressure into the shaping and joining tool 20 in order to coat the base body 2 completely or partially on one side or on both sides, for example in an injection molding method, in particular in a single or multicomponent injection molding method for a component 1 which is coated on both sides or completely. Alternatively and depending on the type of plastic 4, the latter can also be foamed, cast or introduced in a similar way.

Irrespective of the type and manner of the lining—of an injection molded or joined on form—the plastic layer or the plastic 4 has a thickness d of 0.8 mm to 10 mm, preferably between 0.8 mm and 6 mm, depending on the predefined values.

FIG. 8C shows the opening of the shaping and joining tool 10 after one of the elements 2a with the associated plastic structure Ka has been finished.

Here, the individual shaping elements 12 are successively moved in the demolding direction according to the arrows P2 and release the element 2a with the joined on plastic structure Ka.

FIGS. 9A, 9B and 10A, 10B show alternative embodiments of a completed component 1 which has been manufactured using what is referred to as PMA (post-mold assembly) technology. Here, the respective plastic structure K is prefabricated as a module and subsequently inserted into the base body 2, in particular joined on, as a plastic lining, so that corresponding cavities H with a minimum distance a from the plastic structure K are formed in the region of the connection points 8a and 8b.

FIGS. 11A and 11B show an alternative embodiment of a component 1 in which the base body 2 is coated on the inside with the plastic 4. Depending on the use of the component 1, for example merely as a cable duct in which the tightness of the duct 6 is of secondary importance, such small sizes are selected for the cavity H and the minimum distance a that the minimum distance a is virtually zero. Here, the plastic 4 is integrally injection molded on to the base body 2, as has already been explained in more detail above, so that the respective elements 2a, 2b are joined as prefabricated modules and connected to one another.

FIGS. 12A and 12B show a further embodiment of a component 1 in which one of the elements 2b is already provided with plastic 4 as a prefabricated module. The other element 2a has been fabricated separately, as has also the associated plastic structure 4a. All the components—element 2a, plastic structure 4a and prefabricated module composed of the element 2b with plastic 4—are subsequently combined to form a component 1, as described above, forming a cavity H with a minimum distance a between the plastic 4 and connection point 8a or 8b.

Depending on the design and shape of the shaping and joining tool 10, the base body 2 which is lined with plastic 4 can be provided with other plastic structures K than the molds illustrated here. For example, the plastic structure K can be provided as a flow structure or guiding and flow element with corresponding flow diversion shapes, and the plastic structure K can also be embodied as internal ribbing or as a multi-chamber duct. A base body 2 which is provided with such a plastic structure K permits particularly good dimensional rigidity and form structure so that a thin-walled base body 2 is given sufficiently good dimensional rigidity and denting resistance and strength by a correspondingly shaped plastic structure K.

In addition, the upper tool 10 can have various shapes of beads, which can form a surface structure of the base body 2. By injecting the molten plastic, the base body 2 is forced into the beads and formed by injection pressure and provided with the plastic layer 4. Depending on the shape, type and number of the beads in the upper and/or lower tools 10a and 10b, respectively, any desired shapes and patterns, for example longitudinal grooves, transverse grooves, cross patterns or hexagonal patterns can be implemented as surface structure for the base body 2 which is provided with the plastic layer 4.

The component 1 serves, for example, as an instrument panel beam for an air conditioning system and/or heating system. Alternatively, the component 1 may be used as a transverse beam which is arranged under a windshield in a vehicle and is provided as an air guiding duct for air conditioning the passenger compartment of a vehicle and for deicing the windshield. The base body 2 is provided with a plurality of opening areas which are arranged at a distance from one another in the longitudinal direction and have the purpose of feeding in and/or discharging a medium, for example air, which is guided in the duct 6.

Furthermore, such a component 1 can also be used at other locations in a vehicle. Examples are A, B, C, D pillars, longitudinal beams, sill beams, roof struts etc. Air from an air conditioning system (referred to for short as HVAC) can also be fed and distributed to these components 1 in a space saving fashion, the component 1 being embodied as a structure part in the vehicle, in particular as a hollow structure part.

### LIST Of Reference Symbols

1 Component
2 Base body
2a, 2b Elements of the base body
4 Plastic
4a Plastic lining of the element 2a
4b Plastic lining of the element 2b
6 Duct
8a to 8d Connection points
9 Opening
10 Shaping and/or joining tool
10a Upper tool
10b Lower tool
12 Shaping elements
14 Die
a Minimum distance
S Thermal conduction path
H Cavity
K Plastic structure
Ka Plastic structure of the element 2a
Kb Plastic structure of the element 2b
R Edge
V Device

1. Method for manufacturing a component comprising a base body which is at least partially lined with plastic, said component being in particular a hybrid component for a transverse beam of a vehicle or a front-end component in which the base body is formed from at least two elements which can be connected to one another at least one connection point, the inner wall of the base body being lined with plastic in such a way that a cavity is formed in the region of one of the connection points between the connection point and the plastic.

2. The method as claimed in claim 1, in which the size of the cavity is predefined as a function of the type of connection point and/or the thickness of the plastic.

3. The method as claimed in claim 1, in which the cavity has a minimum distance, in particular with a sufficiently large heat conduction path, between the connection point and the plastic of at least 0.8 mm and at most 25 mm.

4. The method as claimed in claim 1, in which the elements are connected to one another in a mechanical and/or materially joined fashion, in particular by welding, bonding, soldering, clinching, chamfering, caulking or by means of the integrally molded, in particular integrally injection molded, plastic.

5. The method as claimed in claim 1, in which the base body is coated, at least partially with plastic, in particular encapsulated by injection molding or foam encapsulated.

6. The method as claimed in claim 5, in which the base body is pressure molded with a predefined design by means of injection pressure.

7. The method as claimed in claim 5, in which the base body is inserted into a shaping and joining tool and is at least partially or completely premolded by closing the shaping and joining tool.

8. The method as claimed in one of claims 5, in which the base body is premolded in the shaping and joining tool by introducing at least one molding element, for example a die, which produces a shape.

9. The method as claimed in claim 5, in which the base body is pressure molded by pressing and/or pressing through the molding element into a predetermined final form.

10. The method as claimed in claim 1, in which the plastic is separately premolded and subsequently inserted into the base body.

11. The method as claimed in claim 1, in which the base body is at least partially provided with plastic on the inside and/or outside.

12. The method as claimed in claim 1, in which the plastic is applied in a single layer or multiple layers and/or with a thickness which varies in certain areas.

13. The method as claimed in claim 1, in which the base body is provided with a plastic structure, in particular with a plastic reinforcing structure, in particular internal ribbing or with a plastic guiding structure, in particular a flow element.

14. The method as claimed in claim 1, in which the plastic is introduced in a single component or multicomponent injection molding method.

15. The method as claimed in claim 1, in which the plastic is applied with a thickness of 0.8 mm to 10 mm.

16. The method as claimed in claim 1, in which a base body which is formed from a metal, lightweight metal or its alloys, in particular aluminum, magnesium, titanium or refined steel, with a wall thickness of 0.4 mm to 2.0 mm is used.

17. The method as claimed in claim 1, in which the base body is lined in certain areas with a physically or chemically foamed material, in particular with a varying wall thickness.

18. The method as claimed in claim 1, in which the base body is molded with a wall thickness which varies in certain areas.

19. A device (V) for manufacturing a component comprising a base body which is at least partially lined with plastic, said component being in particular a hybrid component for a transverse beam of a vehicle, comprising a shaping and/or joining tool with a shaping element in which the base body which comprises at least two elements can be arranged and shaped or joined at least partially or completely by closing the shaping and/or joining tool, it being possible subsequently to form a cavity between the connection point and the plastic when plastic is introduced into the base body in the region of a connection point of the two elements of the base body.

20. The device as claimed in claim 19, the shaping and/or joining tool having a side, in particular an inner wall, which produces the shape corresponding to the contour of the base body.

21. The device as claimed in claim 19, the shaping and joining tool being designed to coat the base body with plastic on one side or both sides.

22. The device as claimed in claim 19, the shaping and/or joining tool being embodied in one piece or a plurality of pieces.

23. The device as claimed in claim 22, the shaping and/or joining tool comprising an upper tool and/or a lower tool.

24. The device as claimed in claim 23, the upper tool and/or lower tool being embodied in one piece or a plurality of pieces.

25. The device as claimed in, the shaping and/or joining tool being an open/close or a slider tool.

26. A component, in particular a hybrid component, for a transverse beam of a vehicle, comprising a base body which is at least partially lined with plastic and which is formed from at least two elements which can be connected to one another at at least one connection point, the base body being provided on the inner walls with plastic in such a way that a cavity is formed in the region of one of the connection points between the connection point and the plastic.

27. The component as claimed in claim 26, in which the size of the cavity is determined as a function of the type of the connection point and/or the thickness of the plastic.

28. The component as claimed in claim 26, in which the cavity has a minimum distance between the connection point and the plastic of at least 0.8 mm and at most 25 mm.

29. The component as claimed in claim 26, in which the elements are provided with edges which bear one against the other in a positively locking fashion in the closed state of the base body and serve to receive at least one of the connection points.

30. The component as claimed in claim 26, in which the elements are connected to one another in mechanical and/or materially joined fashion, in particular by welding, bonding, soldering, clinching, chamfering, caulking or by means of the integrally molded, in particular integrally injection molded plastic.

31. The component as claimed in claim 26, in which the base body is coated at least partially with plastic, in particular encapsulated by injection molding or foam encapsulated.

32. The component as claimed in claim 26, in which the plastic is embodied as a plastic structure.

33. The component as claimed in claim 32, in which the plastic structure is embodied at least partially or completely as a separate module and can be inserted into the base body.

34. The component as claimed in claim 32, in which the plastic structure is embodied as a plastic reinforcing structure, in particular as internal ribbing, and/or as a plastic guiding structure, in particular as a flow element.

35. The component as claimed in claim 26, in which the plastic has a thickness of 0.8 mm to 10 mm.

36. The component as claimed in claim 26, in which the plastic has a varying thickness in certain areas.

37. The component as claimed in claim 26, in which the base body is formed from a metal, lightweight metal or its alloys, in particular aluminum, magnesium, titanium or refined steel, and has a wall thickness of 0.4 mm to 2.0 mm.

38. The component as claimed in claim 26, in which the base body has a varying wall thickness in certain areas.

39. The component as claimed in claim 26, in which the base body is lined in certain areas with a physically or chemically foamed material with a varying wall thickness.

40. A use of a component which is manufactured according to the method as claimed in claim 1, as an instrument panel beam in a vehicle with a duct, in particular with at least one air guiding duct and/or one cable duct.

41. A use of a component which is manufactured according to the method as claimed in claim 1, as a transverse beam in a vehicle, in particular as a transverse beam between the A pillars of a vehicle or as a front-end component.

42. A use of a component which is manufactured according to the method as claimed in claim 1, as a structure part in a vehicle, in particular as a hollow structure part, as a longitudinal beam, sillboard, center tunnel structure, front-part longitudinal beam or transverse beam, vertical structure, A, B, C, D pillar or roof structure part.

43. A use of a component which is manufacture according to the method as claimed in claim 1, as a structure part in a vehicle, in particular as a hollow structure part through which air from a heating, cooling, air conditioning or venting device is guided.

44. A use of a component which is manufactured according to the method as claimed in claim 1, as a transverse beam which is arranged under a windshield in a motor vehicle, the duct being an air guiding duct for guiding an air stream which is to be fed to the windshield and/or the side windows, and/or for heating a wiper blade support.
